(19) United States
(12) Patent Application Publication
(10) Pub. No.: US 2008/0211717 A1
(43) Pub. Date: Sep. 4, 2008

(54) Phased Array Transmitting Antenna

(75) Inventors: Markus Boeck, Elchingen (DE); Hubert Ott, Bernstadt (DE); Helmut Dreher, Ulm (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 11/951,733

(22) Filed: Dec. 6, 2007

(30) Foreign Application Priority Data
Dec. 7, 2006 (DE) 10 2006 057 563.6

(51) Int. Cl. H01Q 3/00

(52) U.S. Cl. 342/377

(57) ABSTRACT

An arrangement for beam forming and control of a transmitter radiating in the RF range comprises an input for feeding the RF transmitting signal RFᵢₙ, a feeding network electrically connected with the input, a plurality of radiator elements, a plurality of phase shifters for receiving signals from the feeding network and for causing phase displacements for the signals before the transmission to the radiator elements, and a controller for controlling the phase displacement caused by the phase shifters. A circuit is assigned to the input of the transmitting antenna for converting the momentary phase of the transmitting signal to a digital word of a definable word length and for feeding the digital momentary phase to the feeding network. Each phase shifter comprises an adder for linking the momentary phase fed by the feeding network with a definable digital phase value generated and fed by the controller, and a circuit for converting the digital output value of the adder to an analog signal. The controller has a set of outputs which are connected with the phase shifters by way of a corresponding set of connection lines, before the transmission to the phase shifters. A definable gradient is superposed on the phase values for generating a phase difference between the phase values at the outputs of the controller.

### BACKGROUND AND SUMMARY OF THE INVENTION

This application claims the priority of German patent document 10 2006 057 563.6, filed Dec. 7, 2006, the disclosure of which is expressly incorporated by reference herein.

The invention relates to a phased array transmitting antenna.

The detection range of a conventional radar system is geometrically defined by a ray which is emitted and received by an antenna, with several such rays normally being used to enlarge the detection range. The plurality of rays is usually achieved by a known phased array (phase-controlled field) of antenna (radiator) elements. In recent years, the significance of digital beam forming, where a plurality of rays is formed by way of digital signal processing, has increased.

The bundling and directing of these rays to form a single strong and targeted beam is the principle of the so-called phase control. In this case, each individual radiator element is controlled and the phase is changed such that it is identical with those of the other radiator elements, and the beam is simultaneously directed in the desired direction. The subsequent superposition of rays has the result that they reinforce one another in the main direction and minimize one another in the undesired secondary directions (secondary lobes). When the signal to be emitted is directed through a module controlling its phase, the radiation direction can be electronically controlled.

The principle of digital beam forming is described in detail, for example, in European Patent Documents EP 1 041 398 B1 and EP 0893 703 B1. In these systems, digital beam forming takes place in the receiving part of the antenna exclusively.

The principle of phased array antennas is also used in military jammers. FIG. 1 illustrates an example of a conventional jammer where the transmitting beam is generated by means of analog phase shifters 2 assigned to an antenna array 1. Jammers are normally also used for deceiving an enemy radar transmitter. It is possible, for example, to generate a transmitting signal by means of a jammer arranged on an airplane, which transmitting signal supplies false information concerning the actual distance between a rocket, and an airplane to the radar transmitter of the rocket or supplies false information concerning a flying maneuver of the airplane to the radar transmitter of the enemy rocket.

An interfering signal is transmitted from an antenna array 1 comprising a plurality of antenna elements 1a which are represented, for example, as a linear array. Each antenna element 1a is connected with a phase shifter 2 by way of a connecting line 3. A distributor network 4 distributes the RF signal RFin to be transmitted to the individual phase shifters 2. A controller 5 supplies a signal to the phase shifters 2, whereby the phases of the individual phase shifters 2 are changed, so that they have a phase difference Δφ at their outputs. By means of this phase difference, the individual transmitting rays of the antenna elements 1a can generate a resulting transmitting beam in a desired direction in space. A change of the phase difference Δφ between the individual antenna elements 1a thus causes a swiveling of the transmitting beam. Amplifiers 6 may also be provided between the individual phase shifters 2 and the respective antenna elements 1a, to amplify the RF signal to be transmitted.

This arrangement, however, has the disadvantage that beam swiveling in the high-frequency position takes place by special high-frequency components, such as power dividers, phase shifters, control electronics of the phase shifters, etc., which are usually expensive. As a result, the overall production costs of the system are increased. In addition, the known arrangement can be used in only one frequency band.

One object of the present invention, therefore, is to avoid the disadvantages of the state of the art.

Another object of the present invention is to provide a transmitting antenna having a simple construction.

These and other objects and advantages are achieved by the phased array transmitting antenna according to the invention, which has an input for feeding an RF signal, a feeding network electrically connected with the input, a plurality of radiator elements, a plurality of phase shifters for receiving signals from the feeding network and for causing phase displacements for the signals before the transmission to the radiator elements and a controller for controlling the phase displacement caused by the phase shifters. A circuit is assigned to the input of the transmitting antenna for converting the momentary phase of the RF signal to a digital word of a definable word length. Moreover, for feeding the digital momentary phase to the feeding network, each phase shifter comprises an adder for combining the momentary phase fed by the feeding network with a definable digital phase value generated and fed by the controller, and a circuit for converting the digital output value of the adder to an analog signal. The controller has a set of outputs connected with the phase shifters by way of a corresponding set of connection lines, before the transmission to the phase shifters, and a definable gradient is superposed on the phase values for generating a phase difference between the phase values at the outputs of the controller.

In the arrangement according to the invention, processing of the phase of the transmission signal (and thus the swiveling of the transmission beam) takes place in the digital domain. The momentary phase of the transmission signal is fed as a digital word to the distributor network and the phase shifters. The length of the digital word expediently is 4 bits. Depending on the precision of the arrangement, however, the word length may also amount to 2ⁿ bits, wherein n=3, 4, 5, 6, 7, 8.

The digital phase value is converted to an analog signal according to the known methods of digital beam forming. In this case, the linear combination of the digital signals present at the output of the phase shifter is computed by means of suitable complex coefficients (that is, having real and imaginary components). The term “suitable” means that they synthesize the analog signal corresponding to normal rules of array antenna technology.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram of a conventional arrangement of a transmitting antenna for transmitting directional interference signals;

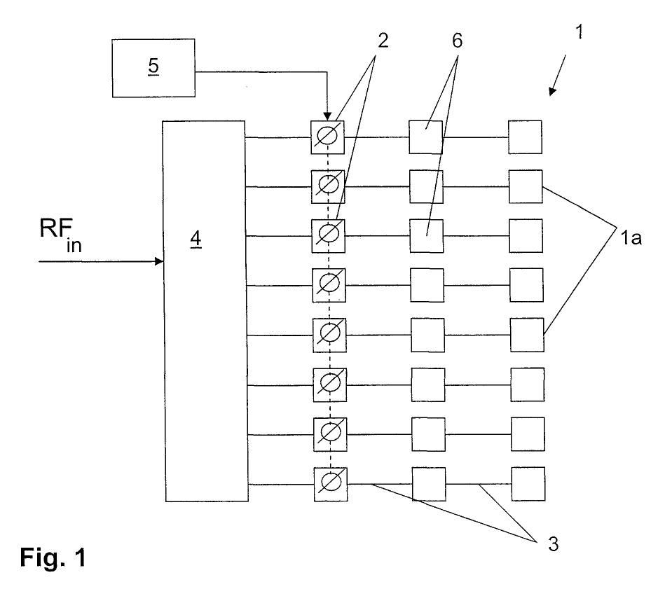

FIG. 2 is a schematic diagram of an embodiment of an antenna arrangement according to the invention for transmitting directional interference signals.

### DETAILED DESCRIPTION OF THE DRAWINGS

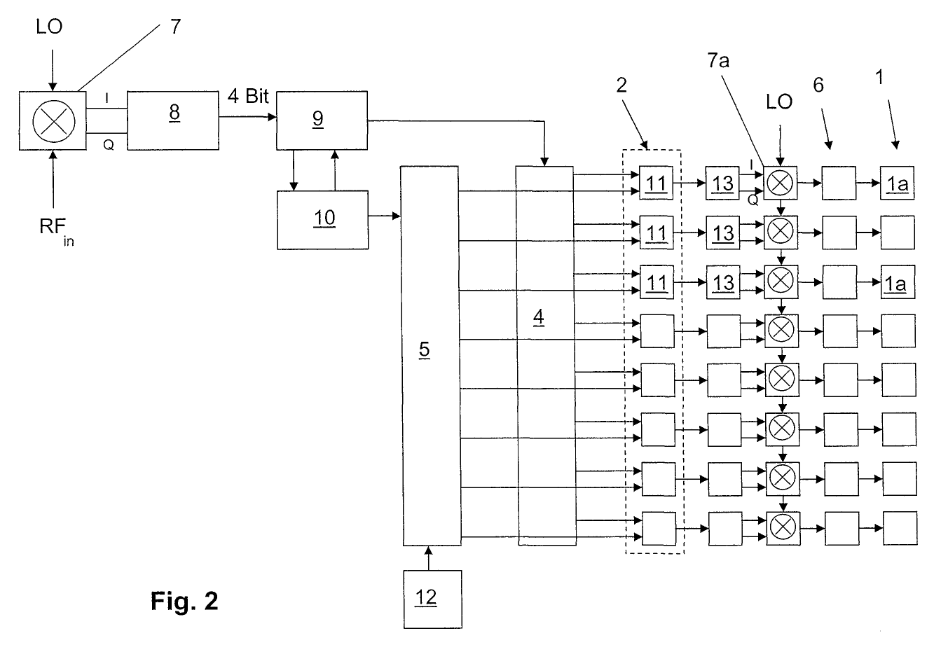

As shown in FIG. 2, an embodiment of an antenna arrangement according to the invention may include a mixer 7, to which the RF signal RFᵢₙ and a constant or tunable-frequency local oscillator signal LO are fed. The RF signal is present at the output of the mixer 7, as a complex signal having a real and imaginary part (I and Q part). As a result of this mixing, the RF signal is transformed into the base band or into an arbitrary band (intermediate frequency). As a result, more costly HF components requiring high expenditures can be avoided.

The generated (base) band signal is subsequently fed to a phase-digital converter circuit 8 which converts the momentary phase applied at a particular point in time to a digital word. In this case, the word length depends on the desired resolution of the beam swiveling. Normally, the digital word length amounts to 4 bits.

The momentary phase may subsequently be stored in a momentary phase memory 9. The latter may have a bidirectional connection with a memory control 10, in which the temporal course of the storage operation and of the read-out operation of the digital moment phase is stored. The momentary phase stored in the momentary phase memory 9 is fed to the feeding network 4 by means of a read-out operation.

However, by means of the memory control 10, defined temporal sequences of instantaneous phases can also be written into the momentary phase memory 9 or be read out of the instantaneous phase memory for further processing for certain interference techniques.

An input of the controller 5 is connected with the memory control 10, so that a phase stored in the memory control 10 can be supplied to the controller 5. By means of this phase, a certain interfering technique of the arrangement according to the invention can be implemented. For example, the emitted interfering signal may supply an enemy radar transmitter with false information concerning the actual distance between the enemy radar transmitter and the object carrying the arrangement according to the invention.

The feeding network 4 and the controller 5 each have a set of outputs. Expediently, the number of outputs is the same in each case and corresponds to the number of radiator elements 1a of the arrangement according to the invention. The feeding network 4 and the controller 5 are connected with phase shifters 2 by way of their outputs.

The number of phase shifters 2 expediently corresponds to the number of radiator elements 1a. Each phase shifter 2 has two inputs. The set of phase shifters 2 therefore has a first set of inputs and a second set of inputs. The first set of inputs is connected with the set of outputs of the feeding network 4, and the second set of inputs is connected with the set of outputs of the controller 5.

The two inputs of a phase shifter 2 are the inputs of an adder 11, which sums the digital phase value of the momentary phase and the phase value supplied by the controller 5. A summed phase value is therefore present at the output of the adder 11.

The summed phase values of the individual adders 11 expediently differ as a result of a phase difference. This phase difference expediently occurs in that the outputs of the controller 5 are superposed with a phase gradient, so that the individual phase values at the outputs of the controller 5 have a mutual phase difference. The phase gradient may expediently be linear. By selection of the gradient, the direction of the interfering signal emitted by the antenna array can be influenced.

The controller 5 expediently has another input. A control signal, for example, of another microcontroller 12, by which the gradient can be controlled, is supplied to this input.

The outputs of the phase shifters (adders) 2, 11 are connected with a set of digital-to-analog converters 13, which convert the digital signal at the output of the respective phase shifter 2 to an analog complex signal (that is, a signal having a linear combination of real and imaginary parts, being in-phase part I and quadrature part Q). Ideally, digital-to-analog converters 13 comprise a look-up table in which a defined linear combination of sine φ and cos φ is assigned to each digital word, φ indicating the phase angle.

The digital-to-analog converter set 13 may be connected with a mixer set 7a by way of connection lines 3. A constant or tunable-frequency (local) oscillator signal LO is also supplied to the mixer set 7a. Expediently, the analog signal supplied to the set mixer 7a and the analog signal LO fed to the mixer 7 are identical.

The mixer set 7a is connected with an antenna array 1, with the radiator element set 1a forming the antenna array 1. Expediently, an amplifier set 6 for amplifying the transmitting signal may be arranged between the mixer set 7a and the radiator element set 1a.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Arrangement for the beam forming and control of a transmitter radiating in the RF range, said arrangement comprising:
an input for feeding the RF transmitting signal RFᵢₙ;
a feeding network electrically connected with the input;
a plurality of radiator elements;
a plurality of phase shifters for receiving signals from the feeding network and for causing phase displacements for the signals before the transmission to the radiator elements; and
a controller for controlling the phase displacement caused by the phase shifters; wherein,
a circuit is assigned to the input of the transmitting antenna for converting momentary phase of the transmitting signal RFᵢₙ to a digital word of a definable word length and for feeding the digital momentary phase to the feeding network;
each phase shifter comprises an adder for combining the moment phase fed by the feeding network with a definable digital phase value generated and fed by the controller, and a circuit for converting the digital output value of the adder (11) to an analog signal;
the controller has a set of outputs which are connected with the phase shifters via a corresponding set of connection lines, before the transmission to the phase shifters; and
a definable gradient is superposed on the phase values for generating a phase difference between the phase values at the outputs of the controller.

2. The arrangement according to claim 1, wherein:
a mixer is connected behind the input; and
the input signal RFᵢₙ and a local oscillator signal LO are fed to the mixer to transform the input signal RFᵢₙ from the RF range into one of an intermediate frequency and a base band.

3. The arrangement according to claim 2, wherein said local oscillator is one of a constant frequency oscillator and a tunable frequency oscillator.

4. The arrangement according to claim 3, wherein:
a mixer is connected in front of the radiator elements; and
the analog signal of the converter assigned to the adder and a local oscillator signal LO are fed to the mixer to transform the analog signal from an intermediate frequency or from the base band into the RF range.

5. The arrangement according to claim 1, further comprising a memory for storing the digital momentary phase and for the transmission of the stored moment phase to the feeding network.

6. The arrangement according to claim 5, further comprising a memory control for controlling the temporal course of the storage operation and of the read-out operation of digital momentary phases.

7. The arrangement according to claim 6, wherein a bidirectional connection exists between the memory and the memory control.

8. The arrangement according to claim 7, wherein the memory control is connected with an input of the controller for transmission of a phase value generated from the stored digital momentary phases.

9. The arrangement according to claim 8, wherein the controller comprises an adder for the digitally combining the phase value fed by the mass memory with the definable phase gradient for generating phase values for the transmission to the phase shifters.

10. The arrangement according to claim 1, wherein the controller has an input for feeding a control signal for influencing the gradient.

11. The arrangement according to claim 1, wherein an amplifier module is assigned to each radiator element for amplifying the analog signal generated by the converter circuit.
